(19) United States
(12) Patent Application Publication
(10) Pub. No.: US 2002/0049074 A1
(43) Pub. Date: Apr. 25, 2002

(54) Method of making a game available for a mobile telephony terminal of a subscriber and program modules and means therefor

(75) Inventors: Bernd Eisinger, Stockern (AT); Gottfried Ullmann, Vienna (AT)

Correspondence Address: SUGHRUE MION ZINN MACPEAK & SEAS, PLLC, 2100 Pennsylvania Avenue, NW, Washington, DC, 20037-3213, US

(73) Assignee: ALCATEL

(21) Appl. No.: 09/907,686

(22) Filed: Jul. 19, 2001

(30) Foreign Application Priority Data
Jul. 20, 2000 (DE) 100 35 348.7

(51) Int. Cl. H04Q 7/20

(52) U.S. Cl. 455/552; 455/426

(57) ABSTRACT

The present invention relates to a method of making a game available for a mobile telephony terminal (TERA) of a subscriber (SUBA), a terminal program module (PMT) therefor, a server program module (PMS) therefor, a charge computer program module (PMAC) for calculating charges in association with the provision of the game, and a mobile telephony terminal (TERA), a server (SER) and a charge billing computer (ACC).

In the method, via a wireless network (NET) the mobile telephony terminal (TERA) sends a server (SER) a request message containing a request for participation in a game and containing an identification code (IDA) of the subscriber (SUBA) which is employed in particular for the use of the network (NET). As a function of the request message, the server executes a games program module (PL) for the execution of the desired game, thereby determines a games result (RESA) and sends this result to the mobile telephony terminal which outputs the result. Additionally, a memory device (DB) stores the at least one result in association with the identification code, it being possible for the result to be retrieved from the memory device (DB) after the game has ended.

### DESCRIPTION

The present invention relates to a method of making a game available for a mobile telephony terminal of a subscriber, a terminal program module therefor, a server program module therefor, a charge computer program module for calculating charges in association with a provision of a game for a mobile telephony terminal of a subscriber, and a mobile telephony terminal with a terminal program module, a server with a server program module, and a charge billing computer with a charge computer program module.

Mobile telephony terminals are used not only in their original area of voice communication, but also for diverse other forms of data communication, for example for sending and receiving so-called SMS messages (SMS=short message system). Recently, other possible uses have been added, for example internet access from mobile telephony terminals, using for example WAP technology (WAP=wireless access protocol) and/or GPRS technology (general packet radio service). In this way, in principle it is also possible to use games made available by internet servers. However not every mobile telephony terminal can provide access to the internet. Furthermore, internet access is generally subject to charges. At any rate, large circles of users are unable to use the games made available on the internet.

Therefore the object of the present invention is to make available games attractive to a subscriber on a mobile telephony terminal of the subscriber.

This object is achieved by a method according to the technical theory of claim 1, a terminal program module according to the technical theory of claim 6, a mobile telephony terminal according to the technical theory of claim 7, a server program module according to the technical theory of claim 8, a server according to the technical theory of claim 9, a charge computer program module according to the technical theory of claim 10, and a charge billing computer according to the technical theory of claim 11.

The invention is based on the principle that a mobile telephony terminal of a subscriber gains access via a wireless network to a games server which enables the subscriber to participate in a game via the mobile telephony terminal. The game is made particularly attractive to the subscriber in that the game can be used not only substantially independently of location, but also in that a result obtained in the relevant game is stored in a memory device from where it can also be retrieved after the game has ended. An assignment of the result to the subscriber is achieved by means of an identification code of the subscriber, which is transmitted from the mobile telephony terminal to the server in association with the request for the game. Here the server is preferably sent an identification code which is employed for the use of the wireless network, and which for example is read by the mobile telephony terminal from a SIM module (SIM=subscriber identity module) required for the operation of the mobile telephony terminal.

Due to the use of a mobile telephony terminal, the game is available at all times and moreover the storage of the result in association with the identification code results in numerous advantageous variants which are described in the dependent claims and in the description.

A game of chance, a competitive game, or a game of knowledge, or also a so-called adventure game can be executed as game for example.

As a function of the relevant game result, a billing amount can be credited or debited to an account of the subscriber. Independently thereof, for the operator of the wireless network and/or games server it is attractive to charge the subscriber a fee for the use of the game. In a preferred variant of the invention, the account can take the form of the charge billing account of the subscriber which is employed for the use of the wireless network.

Furthermore, the result of the game can be entered in a results list, serving for example as so-called high-score list, in which further results of the subscriber and/or of other subscribers are stored. The results list can be retrieved by the subscriber via his mobile telephony terminal, so that the subscriber can look at his current game results and/or game results of the other subscribers.

Further advantages of the invention will become apparent from the dependent claims and the description.

In the following the invention and the advantages thereof will be described in the form of exemplary embodiments making reference to the drawing in which:

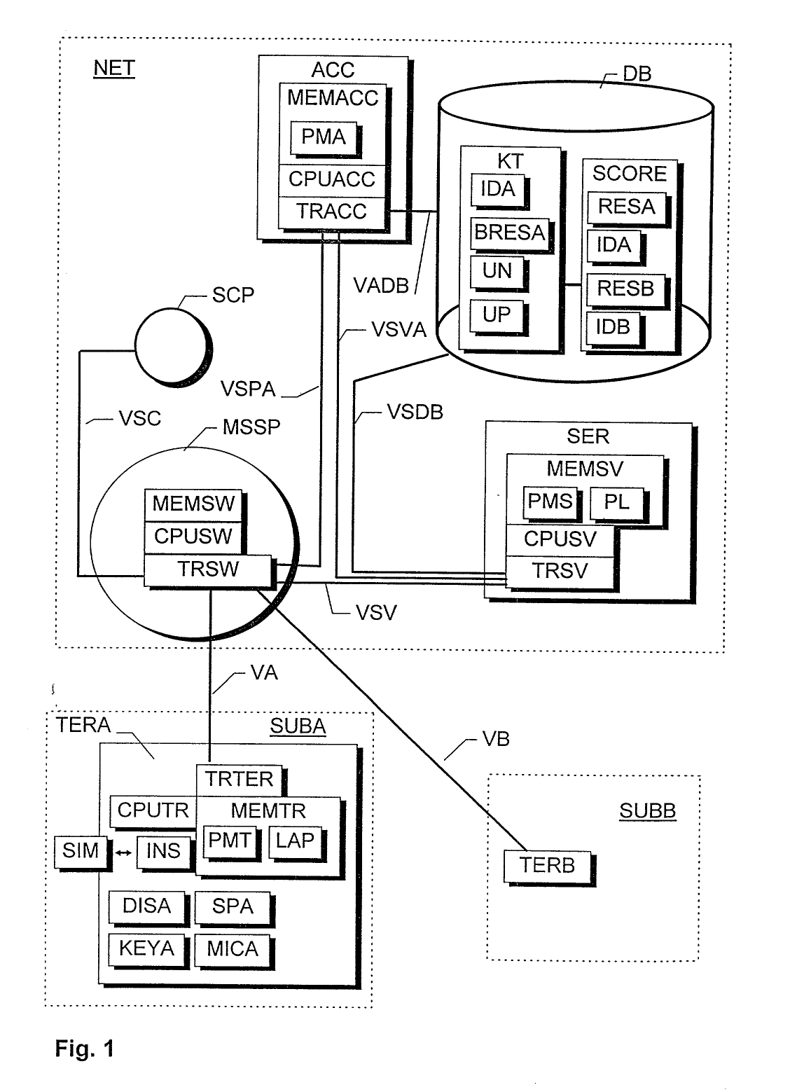

FIG. 1 illustrates an arrangement for the implementation of the method according to the invention, comprising a terminal (TERA) according to the invention, a switching centre MSSP, a service control node SCP, a charge computer ACC according to the invention, a server SER according to the invention, and a memory device DB.

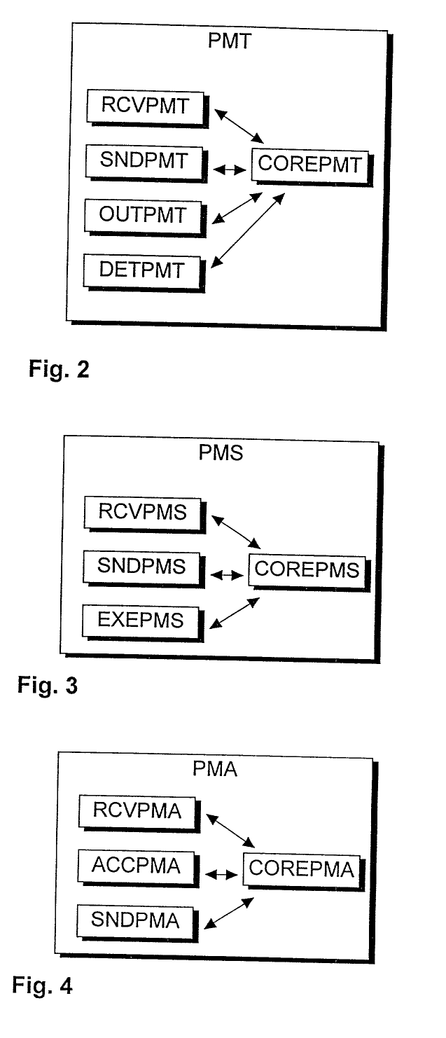

FIG. 2 illustrates a schematic construction of a terminal program module PMT according to the invention.

FIG. 3 illustrates a schematic construction of a server program module PMS according to the invention.

FIG. 4 illustrates a schematic construction of a charge computer program module PMA according to the invention.

FIG. 1 illustrates an example of an arrangement in which the invention can be implemented. FIG. 1 shows a wireless network NET, indicated by a dotted-line box. Subscribers SUBA and SUBB indicated in further dotted-line boxes each have mobile telephony terminals TERA and TERB respectively which are connected via wireless subscriber connections VA and VB respectively to a service switching centre MSSP of the network NET. Via the network NET the terminal TERA and TERB can access a server SER, with the aid of which games are made available to the subscribers SUBA and SUBB at the terminals TERA and TERE respectively.

The terminal TERA is preferably a mobile telephone or a personal computer, personal digital assistant (PDA) or the like equipped for wireless connection to the network NET. The terminal TERA comprises a connection means TRTER which consists for example of an interface module for radio communication according to the specifications of the European Global Systems for Mobile Communications (GSM), the Japanese Personal Handy Phone Sets (PHS), the American Advanced Mobile Phone Systems (AMPS), Digital Enhanced Cordless Telecommunications (DECT) or the UMTS (Universal Mobile Telecommunications System) or the like. With the connection means TRTER, the terminal TERA can establish the connection VA to the network NET. The terminal TERA also comprises a control means CPUTR and a memory means MEMTR. The control means CPUTR is for example a processor with which program code stored in the memory means MEMTR can be executed. The memory means MEMTR consists for example of a hard disc or RAM modules. The terminal TERA also comprises a display means DISA and an input means KEYA. The display means DISA consists for example of a computer monitor or a LCD display (liquid crystal display). The input means KEYA can consist of a keyboard and/or a mouse instrument. The terminal TERA also comprises a loudspeaker SPA and a microphone MICA facilitating voice output and input respectively. With the aid of program code which is stored in the memory means MEMTR and can be executed by the control means CPUTR, in particular program code of a terminal program module referred to in the following as terminal module PMT, the terminal TERA can be used as a terminal for games provided by the server SER.

The terminal TERB is substantially identical to the terminal TERA and therefore will not be explained further.

Of the network NET, which in the exemplary embodiment has the form of an intelligent network (IN), further devices not shown in FIG. 1, for example switching centres, front-end devices and connection lines, have been represented by the switching centre MSSP, a service control node SCP, a memory device DB, the server SER and a charge computer ACC. The switching centre MSSP is a so-called service switching point and the service control node SCP is a so-called service control point of an intelligent network complying with the standards of the ITU (International Telecommunication Union). The switching point MSSP also performs functions of a so-called mobile switching centre. The subscriber connections VA and VB are established by so-called base station subsystems (not shown) which precede, or are integrated into, the switching point MSSP. The base station subsystems each comprise at least one base transceiver station (=BTS) and a base station controller (=BSC) for controlling the base transceiver station.

The switching point MSSP is connected to the service control point SCP via a connection VSC, to the charge computer ACC via a connection VSPA and to the server SER via a connection VSV. The connections VSC and VSV are connections which are preferably routed via a signalling channel or via a signalling network and on which signalling messages are transmitted, for example with the so-called mobility application protocol (MAP) or the camel access protocol (CAP) (CAMEL=Customized Application for Mobile Enhanced Logic). A signalling network of this kind is for example the central signalling system No. 7. Via the connection VSPA the switching point MSSP sends the charge computer ACC so-called charge tickets for voice- and/or data connections which are routed across the switching point MSSP, for example from the subscribers SUBA and SUBB. Charges UN incurred for voice- and/or data connections of the subscriber SUBA are debited by the charge computer ACC to an account KT held in the memory device DB.

The server SER and the charge computer ACC are connected to one another via a connection VSVA and each have access to the memory device DB via connections VSDB and VADB respectively. The connections VSVA, VSDB and VADB are established for example on a LAN (local area network) or a WAN (wide area network) or also on a signalling network.

Only a few essential components of the switching point MSSP have been shown by way of example, namely connection means TRSW and a control means CPUSW and memory means MEMSW. With the connection means TRSW the switching point MSSP can establish data and voice connections to subscribers or other switching points (not shown) as well as signalling connections, such as for example the connection VSC to the service control point SCP. The control means CPUSW consists of a processor or group of processors which can execute commands stored in the memory means MEMSW. The control means CPUSW controls the functions of the switching point MSSP and thereby influences the functions of the connection means TRSW for example. The connection means TRSW, the control means CPUSW and the memory means MEMSW are connected to one another by connections not shown in FIG. 1. The switching point MSSP can also comprise further modules, for example a switching network or an interface to a network management system. In addition to the terminals TERA and TERB, the switching point MSSP also serves other terminals not shown.

The service control point SCP provides services for the switching point MSSP and also for other switching points which have not been shown but are similarly equipped, and controls the provision of services. Such a service is for example the known freecall service (telephone numbers beginning with “0800”).

The server SER comprises a connection means TRSV, a control means CPUSV and memory means MEMSV. The server SER can comprise a computer system which is operated by a UNIX operating system or a Windows NT operating system. The server SER can also consist of a network of computer systems. The control means CPUSV is a processor or cluster of processors which executes the commands of the operating system stored in the memory MEMSV. The memory means MEMSV, which for example comprises a hard disc or RAM modules, also stores program modules whose program code sequences are executed by the control means CPUSV. Such program modules comprise for example a server program module PMS, referred to in the following as server module PMS, which controls the functions of the server SER as games server, and a games program module PL which is called by the server module PMS and is abbreviated to games module PL in the following. The control means CPUSV also influences the functions of the connection means TRSV with which for example the forementioned connections VSV and VSVA can be established. The server SER also comprises further modules not shown in FIG. 1, for example a monitor, keyboard and mouse. The server SER also provides further terminals (not shown) with games via the switching point MSSP or other switching points which have not been shown.

The charge computer ACC is a charge metering device and is representative for example of other charge computers (not shown) of the network NET. The charge computer ACC debits use charges for the use of the network NET to accounts held for subscribers connected to the network NET, for example the subscribers SUBA and SUBB. Accordingly, the charge computer ACC holds an account KT for the subscriber SUBA. Via a connection means TRACC of a transmitting and receiving module, the charge computer ACC receives so-called charge tickets from the switching point MSSP on the connection VSSA or from the server SER on the connection VSVA. Charge tickets are messages stating charges assigned to a subscriber number or subscriber code digit. The charges stated in a charge ticket are then debited by a charge computer program module PMA, abbreviated to charge computer module PMA in the following, of the charge computer ACC to an account held for the subscriber number, in the case of the subscriber SUBA to the account KT. The charge computer module PMA is stored in a memory means MEMACC of the charge computer ACC. Program code contained in the charge computer module PMA is executed by a control means CPUACC, which for example is a processor or processor cluster. The account KT is held for example in a database stored in a memory means MEMACC of the charge computer ACC. In the present case however the data of the account KT are stored in the memory device DB. The memory means MEMACC consists for example of RAM modules and hard-disc drives.

A typical process flow for the provision of a game for the terminal TERA of the subscriber SUBA is explained in the following.

The subscriber SUBA inputs a start command for the execution of a desired game into his terminal TERA, for example on the input means KEYA by depressing a key on a keyboard or by activating a mouse instrument or by a voice command given via the microphone MICA. The terminal module PMT is activated by the start command. The key on the keyboard can be a dedicated key provided for the game or a so-called soft key whose context-dependent function is controlled for example by the terminal module PMT. The terminal module PMT can for example be a program in the programming language Java and can be executed by a WAP browser (WAP=wireless access protocol) and/or a so-called run-time environment comprising for example a Java interpreter.

A read-in function DETPMT of the terminal module PMT, serving as detection means, detects the start command. The read-in function DETPMT is for example a program function activated by a central control section COREPMT of the terminal module PMT. The read-in function DETPMT can also for example be a so-called Java bean if the terminal module PMT is implemented in the programming language Java. In addition to the start command, the read-in function DETPMT detects an identification code IDA of the subscriber SUBA which identifies the subscriber SUBA upon participation in the game. The identification code IDA is for example a character code which the subscriber SUBA can input via the input means KEYA or dictate via the microphone MICA. Preferably however the identification code IDA is an identification code employed for the use of the network NET. In this present case the identification code IDA is stored on a SIM module which the subscriber SUBA inserts into a module reader INS of the terminal TERA in order to operate the terminal TERA. The read-in function DETPMT therefore retrieves the identification code IDA from the module reader INS. However the read-in function DETPMT can possibly also read the identification code IDA from a predetermined area of the memory means MEMTR.

Then the terminal TER sends the server SER a request message containing a request for participation in the game and the identification code IDA. A transmit function SNDPMT serving as transmitting means now prepares the request message and transfers it to the connection means TRTER. The connection means TRTER sends the request message for example as SMS message (SMS=short message system) or as GPRS packet (GPRS=general packet radio service), in each case indicating the address of the server SER, via the connection VA to the switching point MSSP for forwarding via the connection VSV to the server SER. Like the read-in function DETPMT, the transmit function SNDPMT is a program function controlled by the central control section COREPMT.

In another scenario, the terminal TERA does not address the request message directly to the server SER. In this case the request message contains an identifier for the desired game. The terminal TERA firstly sends the request message to the switching point MSSP which, with the aid of the identifier, determines that the request message relates not to a connection request directed to a subscriber but is a service request. The switching point MSSP therefore asks the service control point SCP for instructions regarding the request message. The service control point SCP also instructs the switching point MSSP to establish the connection VSV to the server SER and thus to establish a connection between the terminal TERA and the server SER.

The server SER receives the request message via the connection means TRSV which transfers said message to a receive function RCVPMS, serving as receiving means, of the server module PMS. The receive function RCVPMS can for example be a so-called Java bean or a program function and is called and controlled by a central control section COREPMS of the server module PMS.

An execute function EXEPMS, serving as execution means, of the server module PMS determines from the request message which game the subscriber SUBA would like to play and according to the selection calls a suitable games module stored in the memory MEMSV. In the present case, for the purpose of clarity only one games module PL has been shown, which for example executes or simulates a game of chance, a competitive game or a game of knowledge.

In the execution of the games module PL, different variants are possible, of which a first will firstly be described by way of example.

For example, a lottery number for a lottery can already be contained in the request message. The lottery number can for example have been generated by the terminal module PMT or input by the subscriber SUBA. Then the games module PL generates a lottery number, for example with the aid of a random number generator, and transfers this number to the server module PMS. As result RESA, the server module PMS then determines whether the generated lottery number corresponds to the lottery number, backed by the subscriber SUBA, from the request message and transmits the result RESA to the terminal TERA with the aid of the connection means TRSV and a transmit function SNDPMS, serving as transmitting means, of the server module PMS. The terminal TERA receives the result RESA via the connection means TRTER which forwards the result RESA to receiving means RCVPMT which for example are likewise a function of the terminal module PMT. An output function OUTPMT, serving as output means, of the terminal module PMT then forwards the result RESA to the display means DISA for display for the subscriber SUBA and/or generates a voice message containing the result RESA for output via the loudspeaker SPA.

The result RESA, together with the identification code IDA or a code which is dependent thereon and identifies the subscriber SUBA, are transmitted by the transmit function SNDPMS for storage to the memory device DB from which the result RESA can also be retrieved after the game has ended, for example by means of the terminal TERA, the server SER or the charge computer ACC. The memory device DB enters the result RESA and the identification code IDA in a results list SCORE which already stores a result RESB, likewise obtained by the subscriber SUBB in the execution of a game of the above type, together with his identification code IDB. In the present case the results list SCORE is a so-called high-score list in which the best results in each case obtained in the execution of the above game are in each case entered. The results list SCORE can be requested by each of the terminals TERA and TERB, for example under the control of the server SER.

In the present embodiment the transmit function SNDPMS also sends the result RESA, together with the identification code IDA or a code which is dependent thereon and identifies the subscriber SUBA, to the charge computer ACC which receives these information items via the connection means TRACC and forwards them to a receive function RCVPMA, serving as receiving means, of the charge computer module PMA. The receive function RCVPMA, an accounting function ACCPMA serving as accounting means, and a transmit function SNDPMA each constitute program functions or program parts which are controlled and called by a central control section COREPMA of the charge computer module PMA. The accounting function ACCPMA determines games result billing data BRESA from the result RESA and games use billing data UP incurred for the use of the games module PL. The games billing data BRESA and UP and the identification code IDA are forwarded to the transmit function SNDPMA for transmission to the memory device DB, which enters the games billing data BRESA and UP in the account KT. If the subscriber SUBA for example had stated a correct lottery number in the request message, the games result billing data BRESA are entered as a win. The subscriber SUBA later receives an invoice, for example a telephone invoice, for the billing data BRESA, UN and UP entered for the account KT.

The games result billing data BRESA and/or the games use billing data UP could however also be entered in a separate account of the subscriber SUBA. Furthermore, the account KT can also be held in the memory means MEMACC.

However, the account KT could also be a so-called prepaid account which can be used by the subscriber SUBA only as long as the account KT contains a credit balance. In this case, prior to the execution of the game desired in the relevant request message, for example the switching point MSSP and/or the server SER checks whether a credit balance still exists. The server SER then executes a game desired by the subscriber SUBA only if a credit balance exists.

It is also possible for example for the charge computer ACC to enter in the account KT, for example every month, a predetermined credit for participation in the game, from which it would be possible for example to deduct the billing data UP, possibly also negative games result billing data BRESA if the subscriber SUBA had stated an incorrect lottery number in the request message. For example the subscriber SUBA could participate ten times a month free-of-charge in the above described lottery.

It is also possible for the server SER to send the result RESA only to the memory device DB and not to the charge computer ACC. Also the server SER could send the result RESA not to the memory device DB but only to the charge computer ACC for storage and accounting.

It is also possible for the server module PMS to determine the games result billing data BRESA and/or the games use billing data UP and to send these to the charge computer ACC and/or to the memory device DB for accounting or only for storage. The games result billing data BRESA and/or the games use billing data UP could then be processed later, for example in the course of a monthly billing, by a charge billing computer (not shown). Charge billing computers are often also referred to as billing centre (BC) or customer care and billing centre (CCBC).

Further games variants are described by way of example in the following:

The results list SCORE could for example be used for the organisation of a monthly lottery, as it were as “second chance” in which lots are cast among the games subscribers entered in the results list SCORE for another win which is determined for example by the server SER and which the charge computer ACC enters in the respective accounts of the games subscribers e.g. the account KT. In particular in a scenario of this kind the results list SCORE expediently is not only a high-score list in which only “winners” are entered, but a list in which quite generally lottery numbers keyed in by games subscribers are entered, i.e. also lottery numbers which were unsuccessful in the “first chance”.

Additionally, via the display means DISA the terminal module PMT could display an input and/or selection field for example to the subscriber SUBA, in which the subscriber SUBA enters a betting number for a football- and/or number bet. This backed betting number is transmitted by the terminal TERA to the server SER in a games request message. The server SER firstly stores the backed betting number in the memory device DB. When the relevant betting result later becomes available for the event on which the bet is based, for example a football game, car race or number lottery, the server SER compares the bet result with the betting number backed by the subscriber SUBA. The relevant determined result is transmitted by the server SER to the terminal TERA and to the memory device DB and/or to the charge computer ACC for the further processing already described.

The terminal TERA and the server SER can also cooperate interactively in the provision of a game desired by the subscriber SUBA. For example, the server SER could send the terminal TERA a knowledge question which the subscriber SUBA must answer. In the event of a correct answer, a billing amount is then credited to the account KT.

Additionally, the terminal module PMT can comprise a random generator which in each case enters a bet random code in a games request message directed to the server SER. On receipt of the games request message, the server module PMS compares the bet random code with a target random code which either is generated ad hoc (see above) or is retrieved from a list of already registered target random codes. If bet random code and target random code correspond, the subscriber SUBA receives a credit to his account KT.

In another variant the subscribers SUBA and SUBB jointly play a game made available by the server SER. The server SER submits knowledge questions for example to both subscribers, the subscriber who gives the correct answer first receiving a credit to his account.

It will be obvious that any other games, for example so-called adventure games, can be executed by the server module PMS. Furthermore, games combinations are possible, for example a combination of a competitive game or lottery game with a knowledge game.

The program code required for the games provision can be contained entirely in the terminal module PMT. However it is also possible that, in the course of the games provision, the server SER sends the terminal TERA program code of an applications program module LAP, for example in the form of Java applets and/or macro-code.

Program code of the applications program module LAP or of the terminal module PMT can for example control the display on the display means DISA and/or generate outputs via the loudspeaker SPA, thereby simulating an automatic gaming machine for example. Also the program code could control a keyboard of the input means KEYA such that its keys serve at least partially as so-called soft keys for controlling the game currently being executed. Then during the game for example each depression of such a soft key can lead to a message to the server SER in each case containing a lottery stake and thus lead to a game (partial) win or a game (partial) loss.

It is also possible for the terminal module PMT to be loaded onto the terminal TERA by the server SER or another server not shown. For this purpose, for example with the aid of the previously mentioned WAP browser, the terminal TERA could send a request to the server SER which then downloads the terminal module PMT onto the terminal TERA.

Different modifications of the devices shown are readily possible. For example, the charge computer ACC can be integrated in the switching point MSSP or in the server SER. Then the control means CPUSW and the control means CPUSV fulfil the functions of the control means CPUACC, the memory means MEMSW and the memory means MEMSV fulfil the functions of the memory means MEMACC, and the connection means TRSW and the connection means TRSV fulfil the functions of the connection means TRACC. The connections VSPA and VSVA are then internal connections in the switching point MSSP and in the server SER. The server SER can also be integrated in the switching point MSSP, or the switching point MSSP can execute the program modules PMS and PL. It is also possible for the switching point MSSP to execute the charge computer module PMA.

In another variant, the server SER and/or the charge computer ACC are integrated in the service control point SCP. Then the service control point SCP executes the server module PMS and the games module PL and charge computer module PMA.

The switching point MSSP and service control point SCP can also be combined to form one unit, a so-called service switching and control point (SSCP) which, depending upon the configuration, executes the charge computer module PMA and/or the server module PMS and/or the games module PL.

Furthermore the games module PL can be integrated in the server module PMS, for example as a program code section or a program function. It is also possible for the charge computer module PMA to be integrated in the server module PMS which then is executed for example by the server SER, the switching point MSSP or the charge computer ACC.

It will be obvious that the charge computer module PMA, the terminal module PMT and the server module PMS can each be implemented in different programming languages, for example Java, C, C++ and the like. Furthermore, the module architecture in each case shown is to be considered only as an example. The individual functions, for example the receive function RCVPMA and the accounting function ACCPMA of the charge computer module PMA, can also be implemented as separate program modules which in a functional unit form the charge computer module PMA and interact under the control of the central control section COREPMA, or also interact directly without the participation of the central control section COREPMA.

1. A method of making a game available for a mobile telephony terminal (TERA) of a subscriber (SUBA) wherein
via a wireless network (NET) the mobile telephony terminal (TERA) sends a server (SER) a request message containing a request for participation in a game and containing an identification code (IDA) of the subscriber (SUBA) which is employed in particular for the use of the wireless network (NET),
as a function of the request message the server (SER) executes a games program module (PL) for the execution of the desired game and thereby determines at least one result (RESA) of the game,
the server (SER) sends the mobile telephony terminal (TERA) the at least one result (RESA) resulting from the execution of the games program module (PL),
the mobile telephony terminal (TERA) outputs the at least one result (RESA) and
a memory device (DB) stores the at least one result (RESA) in association with the identification code (IDA), it being possible for the at least one result (RESA) to be retrieved from the memory device (DB) after the game has ended.

2. A method according to claim 1, characterised in that games billing data (BRESA, UN) are determined from the at least one result (RESA) of the game and/or for the use of the games program module (PL), and that the games billing data are entered in an account (KT) of the subscriber (SUBA), in particular a charge billing account of the subscriber (UBA) which is employed for the use of the wireless network (NET).

3. A method according to claim 1, characterised in that the games program module (PL) executes a game of chance, a competitive game, or a game of knowledge.

4. A method according to claim 1, characterised in that the at least one result (RESA) of the game is entered in a results list (SCORE) in which at least one second result (RESB) of the game, obtained by a second subscriber (SUBB), is stored.

5. A method according to claim 1, characterised in that the games program module (PL) sends an applications program module (LAP) to the mobile telephony terminal (TERA), the program code of which is executed by the mobile telephony terminal (TERA) for the execution of the game in interaction with the server (SER).

6. A terminal program module (PMT) for a mobile telephony terminal (TERA) of a subscriber (SUBA), which is provided for a wireless network (NET), for making a game available for the mobile telephony terminal (TERA), wherein the terminal program module (PMT) can be executed by a control means of the mobile telephony terminal (TERA), characterised in that
the terminal program module (PMT) comprises detection means (DETPMT) for detecting a start command given by the subscriber (SUBA) for the execution of the game, and for determining an identification code (IDA) of the subscriber (SUBA) employed in particular for the use of the wireless network (NET),
the terminal program module (PMT) comprises transmitting means (SNDPMT) for sending a request message, containing a request for participation in the game and containing the identification code (IDA), to a server (SER) via the wireless network (NET),
the terminal program module (PMT) comprises receiving means (RCVPMT) for receiving at least one result (RESA) resulting from the execution of the games program module (PL) and
the terminal program module (PMT) comprises output means (OUTPMT) for outputting the at least one result (RESA) on an output device of the mobile telephony terminal (TERA).

7. A mobile telephony terminal (TERA) for a wireless network (NET) comprising a terminal program module (PMT) according to claim 6 and comprising a control means (CPUTR) for the execution of the terminal program module (PMT).

8. A server program module (PMS) for a server (SER) for making a game available for a mobile telephony terminal (TERA) of a subscriber (SUBA), wherein the server program module (PMS) can be executed by a control means (CPUSV) of the server (SER), characterised in that
the server program module (PMS) comprises receiving means (RCVPMS) for receiving a request message containing a request, sent by a mobile telephony terminal (TERA), for participation in the game, and containing an identification code (IDA) of the subscriber (SUBA), employed in particular for the use of the wireless network (NET),
the server program module (PMS) comprises execution means (EXEPMS) for the execution of a games program module (PL) for the execution of the desired game as a function of the request message and for determining at least one result (RESA) of the game,
the server program module (PMS) comprises transmitting means (SNDPMS) for sending the at least one result (RESA), resulting from the execution of the games program module (PL), to the mobile telephony terminal (TERA),
and the transmitting means (SNDPMS) are designed to transmit the at least one result (RESA), resulting from the execution of the games program module (PL), in association with the identification code (IDA) to a memory device (DB) from which the at least one result (RESA) can be retrieved after the game has ended.

9. A server (SER) with a server program module (PMS) according to claim 8 and with a control means (CPUSV) for executing the server program module (PMS).

10. A charge computer program module (PMA) for a charge computer (ACC) for calculating charges in connection with a provision of a game for a mobile telephony terminal (TERA) of a subscriber (SUBA) for a wireless network (NET), wherein the charge computer program module (PMA) can be executed by a control means (CPUACC) of the charge computer (ACC), characterised in that
the charge computer program module (PMA) comprises receiving means (RCVPMA) for receiving an identification code (IDA) of the subscriber (SUBA), which is employed in particular for the use of the wireless network (NET), in association with at least one result (RESA) of the game which the server (SER) executes as a function of a request message, sent by the mobile telephony terminal (TERA) via a wireless network (NET), with the aid of a games program module (PL) for the execution of the desired game, where the server (SER) determines the at least one result (RESA) of the game and
the charge computer program module (PMA) comprises accounting means (ACCPMA) for entering games billing data, determined from the at least one result (RESA) of the game and/or for the use of the games program module (PL), in an account of the subscriber (SUBA), in particular a charge billing account of the subscriber (SUBA) which is employed for the use of the wireless network (NET).

11. A charge computer (ACC) comprising a charge computer program module (PMA) according to claim 10 and a control means (CPUACC) for the execution of the charge computer program module (PMA).

12. A memory means with a terminal program module (PMT) according to claim 6 and/or a server program module (PMS) according to claim 8 and/or a charge computer program module (PMA) according to claim 10.
